(19) United States
(12) Patent Application Publication
(10) Pub. No.: US 2006/0250828 A1
(43) Pub. Date: Nov. 9, 2006

(54) Inverter power electronics design

(76) Inventor: Bill Taylor, Bend, OR (US)

Correspondence Address: John Vanden Bosche, 6571 Lunde Rd, Everson, WA, 98247, US

(21) Appl. No.: 11/400,720

(22) Filed: Apr. 7, 2006

Related U.S. Application Data
(60) Provisional application No. 60/669,487, filed on Apr. 7, 2005.

(51) Int. Cl. H02M 7/48; H02B 7/00

(52) U.S. Cl. 363/71; 363/146; 363/17; 363/56.01; 361/605; 361/707

(57) ABSTRACT

An inverter design with makes use of an integrated power module in place of discrete transistors. The use of an integrated power module facilitates the creation of a field replaceable component consisting of the power module and a circuit board with control and other circuitry.

### RELATED APPLICATIONS

This application claims priority under 35 U.S.C. § 119(e) to U.S. Provisional Patent Application No. 60/669,487 which was filed on Apr. 7, 2005, incorporated Herein by reference. Co-pending patent application Ser. No. 11/187,059 is also incorporated herein by reference.

### FIELD OF THE INVENTION

The invention relates to the inverter design, specifically to power electronics design of a solar power inverter.

### BACKGROUND OF THE INVENTION

The solar energy industry is expanding at a rapid pace. Much of that expansion is due to increases in residential and small commercial photovoltaic (PV) installations. Increasingly these installations are directly connected to the utility grid without the use of batteries. Inverters are the power electronics equipment that converts DC electricity produced by PV panels (collectively a PV array) into AC required by the grid.

Inverters used in the solar energy industry use controllable transistors (such as MOSFETs or IGBTs) to convert DC electricity produced by solar panels into AC electricity which is used on site or injected into a utility grid. Prior art solar power inverters have all assembled individual transistors into the desired circuit and provided mounting, and heat sink connection for each of the transistors. This approach is useful if individual transistors are to be replaced and it allows for customizing the layout of and auxiliary circuitry to the transistors. Unfortunatly replacing individual transistors requires specialized equipment and significant technician time. Thus prior art inverters typically need to be shipped to a service facility to be repaired. The additional cost of shipping and technician time is usually far greater than the cost of the transistors. It would be advantageous to provide an inverter that utilized modular components that could be easily replaced in the field.

An integrated power module (IPM) is essentially a collection of transistors (for example 4 to 6 IGBTs) in a common package. An IPM also includes some gate drive circuitry which biases the transistors in a manner that allows them to be switched. The IPM package contains circuitry to gate the individual IGBT devices but the gating signals come from an external source, likely a digital signal processor (DSP). Additionally IPM design usually incorporates circuitry that protects the device in the event of an over current of the transistors and may contain other protection and feedback circuitry. An IPM effectively incorporates many components into a single package.

It would be advantageous to provide a solar power inverter design which incorporated an IPM instead of individual transistors. Such a design would decrease part count substantially.

### SUMMARY OF THE INVENTION

The present invention is an inverter design which incorporates an integrated power module (IPM) instead of using individual transistors. By using an IPM not only is the part count of the inverter reduced but an integrated module is a proven and tested device, and has the latest silicon technology and integrated circuitry to give better efficiency. The module has an integrated thermal interface that has a large surface area allowing easy mounting to a heat sink. The module may be soldered into a circuit board and is keyed so that it can only be installed in the correct orientation. An IPM soldered to a circuit board containing the circuitry to control the IPM and optionally other circuitry may be designed as a module which can be replaced within an inverter in the field by a local technician.

Additional features and advantages according to the invention in its various embodiments will be apparent from the remainder of this disclosure.

### BRIEF DESCRIPTION OF THE DRAWINGS

Features and advantages according to embodiments of the invention will be apparent from the following Detailed Description taken in conjunction with the accompanying drawings, in which:

FIG. 1 shows an integrated power module according to embodiments of the present invention

FIG. 2 shows an integrated power module installed with a heat sink and control circuit board according to embodiments of the present invention.

### DETAILED DESCRIPTION OF THE DRAWINGS

The description of specific embodiments herein is for demonstration purposes and in no way limits the scope of this disclosure to exclude other not specifically described embodiments of the present invention.

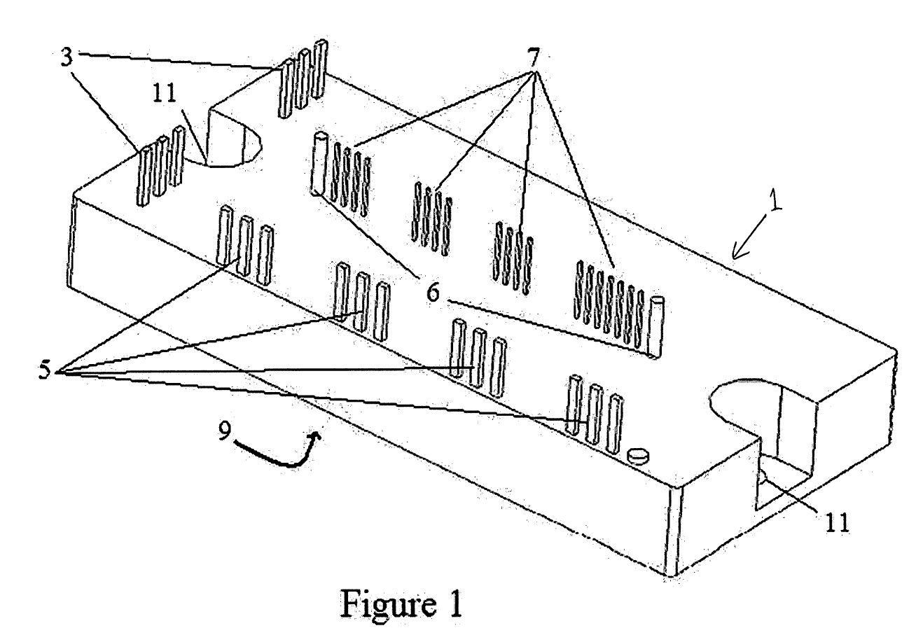

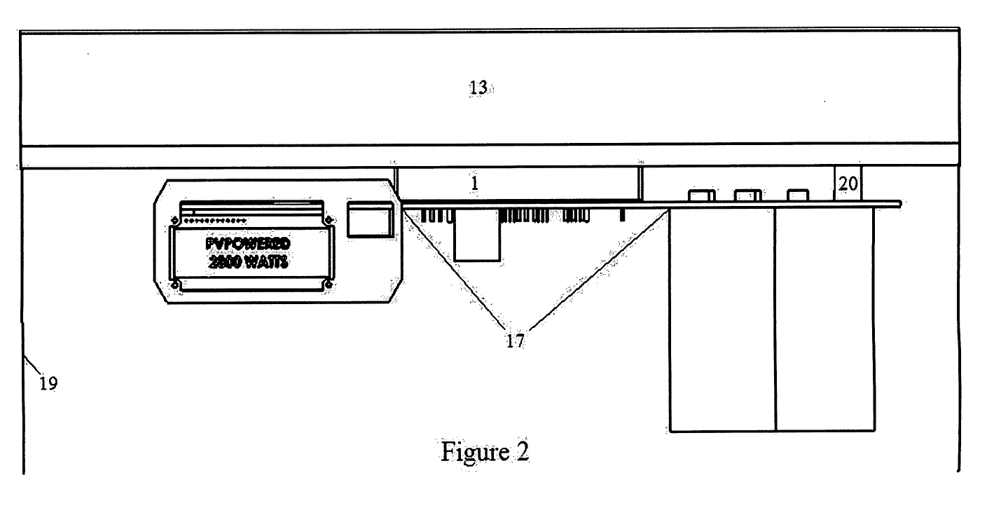

FIG. 1 shows an integrated power module (IPM) 1 the shape and pin layout of the IPM 1 shown is that of a PowerEx PM75B4LB060, but the general types of connections are common between most types of IPM 1. Shown connections are DC connectors 3, AC connectors 5, guide pins 6, and control inputs 7. The control inputs 7 are for gating and setting up bias power supplies. The back side of the IPM 1, as shown in FIG. 1, is a flat heat exchange surface 9. Bolt holes 11 allow the IPM to be mounted to a heat sink 13 (shown in FIG. 2) with the heat exchange surface 9 in good thermal contact with the heat sink 13, optionally held in place with bolts or other suitable fastener. All of the connectors 3, 5, 6, and 7 may optionally be soldered or otherwise connected to a circuit board 17. The circuit board 17 may optionally contain a digital signal processor (DSP) and auxiliary circuitry for controlling and commanding the IPM 1. Furthermore the circuit board 17 may gain all or part of its mounting support within a solar power inverter enclosure 19 from its soldered connection to the IPM 1. Optionally additional circuit board supports and fasteners 20 may be provided. The IPM 1 and circuit board 17 may be mounted such that physical and electrical connections are accessible within the enclosure 19 such that a module consisting of the IPM 1 and circuit board 17 can be removed and replaced in the field. This provides a significant advantage over prior art solar inverters using individual transistors. Specific off the shelf IPMs 1 found to be especially suitable for use in a solar power inverter are the PowerEx models PM75B4L and PS11037.a although other similar IPMs could be used, as will be apparent to one of ordinary skill in the art.

In the present invention an IPM 1 is used to provide transistors in a solar power inverter. The innovation of using an IPM 1 precludes replacement of individual transistors and requires a design approach centered on making effective use of a standard IPM 1. The use of an IPM 1 in a solar inverter is novel and has hot been used in any prior art solar power inverter. The disclosed design shows that the use of an IPM 1 can greatly simplify and aid in modularization of inverter design.

While an embodiment of the invention has been shown and described, it will be apparent to those skilled in the art that various modifications may be made without departing from the scope of the invention. Therefore, it is intended that the invention not necessarily be limited to the particular embodiments described and illustrated herein.

What is claimed is:

1. An inverter connected to a photovoltaic panel comprising:
a photovoltaic panel, an output of which is DC power; and
a set of transistors electrically connected to said photovoltaic panel that controllably convert said DC power into AC power wherein said transistors are contained in an integrated power module.

2. The inverter of claim 1 wherein said integrated power module is attached to a circuit board that also contains control and other circuitry such that said integrated power module and circuit board together form a removable subassembly that is easily removed and replaced in the field.

3. The inverter of claim 1 wherein said integrated power module has a front side with electrical connectors and a back side is a flat heat exchange surface and wherein said inverter further comprises a heat sink wherein said flat heat exchange surface is in contact with said heat sink.

4. The inverter of claim 2 wherein said integrated power module has a front side with electrical connectors and a back side is a flat heat exchange surface and wherein said inverter further comprises a heat sink wherein said flat heat exchange surface is in contact with said heat sink.

5. The inverter of claim 3 wherein said integrated power module is a PowerEx model PM75B4L or PowerEx model PS11037.

6. The inverter of claim 4 wherein said integrated power module is a PowerEx
